(19) United States
(12) Patent Application Publication
(10) Pub. No.: US 2023/0273925 A1
(43) Pub. Date: Aug. 31, 2023

(54) METHOD AND APPARATUS FOR DATABASE MANAGEMENT SYSTEM QUERY PLANNING

(71) Applicant: HUAWEI CLOUD COMPUTING TECHNOLOGIES CO., LTD., Gui Zhou Province (CN)

(72) Inventors: Yifan LI, Toronto (CA); Xiaohui YU, Oakville (CA); Nikolaos KOUDAS, Toronto (US); Shu LIN, Richmond Hill (CA); Calvin SUN, Markham (CA); Chong CHEN, Richmond Hill (CA)

(73) Assignees: HUAWEI CLOUD COMPUTING TECHNOLOGIES CO., LTD., Gui Zhou Province (CN); York University, Toronto (CA)

(21) Appl. No.: 17/681,232

(22) Filed: Feb. 25, 2022

(51) Int. Cl. G06F 16/2453; G06F 16/2458; G06F 11/34

(52) U.S. Cl. CPC G06F 16/24545; G06F 16/2462; G06F 11/3419

(57) ABSTRACT

The present disclosure provides methods and apparatus for calibrating cost estimator for trustworthy DBMS performance. An aspect of the disclosure provides for a method, which includes generating a plurality of plans for potential execution by a DBMS, each of the plurality of plans being configured to generate a same response to a same specified database query. The method further includes generating, for each plan, a set of probability-cost value pairs, each indicative of an estimated upper cost for said plan and a probability that a cost for said plan will be equal to or less than said estimated upper cost, if and when said plan is executed. The method further includes selecting one of the plurality of plans based at least in part on an evaluation of the sets of probability-cost value pairs for the plurality of plans, and causing the DBMS to execute the selected plan.

### CROSS-REFERENCE TO RELATED APPLICATIONS

This is the first application filed for the present invention.

### FIELD OF THE INVENTION

The present invention pertains to the field of database management system (DBMS), and in particular to a method and apparatus for planning how to implement queries in a DBMS.

### BACKGROUND

The DBMS architecture is widely used to organize, retrieve and analyze data. Users interact with a DBMS by asking queries, and the DBMS may use cost estimators, among other components, to identify plans for obtaining query results. Existing cost estimators suffer from uncertainties, which may relate to the possibility of a difference between an estimated cost of a plan and the actual cost (e.g., runtime) of the plan. These uncertainties can lead to suboptimal or even catastrophic plan selection.

The robust query optimizer is an existing solution that aims to to quantify the “predictability” of cardinality estimation and balance between performance and predictability during plan selection. Robust query optimizer is described in Babcock, Brian, and Surajit Chaudhuri. “Towards a robust query optimizer: a principled and practical approach.” Proceedings of the 2005 ACM SIGMOD international conference on Management of data. 2005. The robust query optimizer involves maintaining random tuples from tables in the DBMS and running a given query on these random tuples. The technique further involves computing the probability distribution for the query's actual selectivity based on observed selectivity from the random tuples using Bayes' rule. A user can then specify a threshold a in range [0,1], and the a-th quantile (e.g., 30% quantile) of the query's selectivity distribution is used as its estimated selectivity. The cost of each plan is then computed based on the selectivity estimation corresponding to the a-th quantile. The plan with the lowest estimated cost is used as the execution plan.

While some cost estimators, such as the robust query optimizer, attempt to address the uncertainty problem, existing solutions still have their limitations. For example, these cost estimators make assumptions regarding the selectivity distributions (probability distribution of predicate selectivity, see above-cited paper), such as following a uniform or beta distribution, or requiring knowledge of the actual selectivity distribution. However, these solutions may only be applicable in limited scenarios, and further may be limited to a certain type of cost estimators.

Therefore, there is a need for a method that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The present disclosure provides methods and apparatus for DBMS query planning and associated cost estimation. Multiple plans for execution by the DBMS in order to implement a given query can be compared with each other based on a statistical approach that returns estimated costs and respective probabilities that the actual cost will be less than or equal to one of the estimated costs. A cost can be based partially or fully on the amount of time taken to execute a plan. The plan which is associated with a desirable estimated cost and probability can be selected for execution in order to implement the query.

A first aspect of the disclosure provides for a method. The method includes generating a plurality of plans for potential execution by a DBMS. Each of the plurality of plans is configured, when executed by the DBMS, to generate a same response (in terms of the ultimate query result) to a same specified database query. The method further includes generating, for each plan of the plurality of plans, a set of probability-cost value pairs. Each probability-cost value pair is indicative of an estimated upper cost for its associated plan and a probability that a cost for said plan will be equal to or less than said estimated upper cost, if and when said plan is executed. The method further includes selecting one of the plurality of plans based at least in part on an evaluation of the sets of probability-cost value pairs for the plurality of plans. The method may further include causing the DBMS to execute the selected one of the plurality of plans.

In some embodiments of the first aspect, the cost for a plan is an amount of time that the DBMS takes to execute the plan. In this case, the estimated upper cost for said plan is an estimated maximum amount of time that the DBMS will take to execute said plan.

In some embodiments of the first aspect, generating the set of probability-cost value pairs includes generating, for each plan of the plurality of plans, a respective estimated cost for that plan.

In some embodiments of the first aspect, generating the set of probability-cost value pairs further includes, for each plan of the plurality of plans and for each probability value of a set of probability values, providing the probability value and the plan to an estimation module. In some embodiments of the first aspect, generating the set of probability-cost value pairs further includes, for each plan of the plurality of plans and for each probability value of a set of probability values, subsequently receiving, from the estimation module, a cost value such that, with probability equal to the probability value, an expected cost incurred by the plan is less than or equal to the cost value. In some embodiments of the first aspect, generating the set of probability-cost value pairs further includes, for each plan of the plurality of plans and for each probability value of a set of probability values, setting one of the set of probability-cost value pairs to be equal to the probability value paired with the cost value.

In some embodiments of the first aspect, the estimation module operates based on a conformal technique.

In some embodiments of the first aspect, the conformal technique is previously initialized based on a plurality of examples. Each example can be indicative of a DBMS query plan, an estimated cost for the DBMS query plan, and an actual cost incurred by implementing the DBMS query plan.

In some embodiments of the first aspect, selecting one of the plurality of plans may further be based on user-generated preferences.

In some embodiments of the first aspect, selecting one of the plurality of plans may include presenting output to a user and receiving input from the user in response to the output. The output can be indicative of the set of probability-cost value pairs, in which each pair is indexed to a corresponding plan of the plurality of plans. In some embodiments of the first aspect, selecting one of the plurality of plans may further be based on a user-selected plan of the plurality of plans. In some embodiments of the first aspect, selecting one of the plurality of plans may further include selecting the user-selected plan amongst the plurality of plans.

In some embodiments of the first aspect, selecting one of the plurality of plans may further include selecting one of the plurality of plans which has the highest probability that the cost for the plan will be less than or equal to an indicated maximum acceptable single query cost.

In some embodiments of the first aspect, the maximum acceptable single query cost can be based on a user-generated preference.

In some embodiments of the first aspect, the method further includes, based on an indication, operating in either a first mode or a second mode. The first mode can be characterized in that more certainty in cost is preferred rather than lower cost. The second mode can be characterized in that lower cost is preferred rather than more certainty in cost. In some embodiments of the first aspect, in the first mode, selecting one of the plurality of plans may include selecting a probability level greater than 50%. In some embodiments of the first aspect, in the first mode, selecting one of the plurality of plans may further include comparing the plurality of plans based on their estimated upper costs. Each plan's estimated upper cost can be paired with a selected probability level. In some embodiments of the first aspect, in the first mode, selecting one of the plurality of plans may further include selecting one of the plurality of plans which has the lowest estimated upper costs paired. Each plan's estimated upper costs can be paired with a selected probability level. In some embodiments of the first aspect, in the second mode, selecting one of the plurality of plans may include selecting one of the plurality of plans which has the lowest estimated cost.

In some embodiments of the first aspect, the indication is obtained from a user-generated preference.

In some embodiments of the first aspect, selecting one of the plurality of plans may include selecting a probability level that is greater than 50%. In some embodiments of the first aspect, selecting one of the plurality of plans may further include comparing the plurality of plans based on their estimated upper costs. Each plan's estimated upper cost can be paired with a selected probability level. In some embodiments of the first aspect, selecting one of the plurality of plans may further include selecting one of the plurality of plans which has the lowest estimated upper costs paired with a selected probability level.

In some embodiments of the first aspect, the selected probability level can be greater than one of: 60%, 70%, 80%, 90%, 95% and 99%.

In some embodiments of the first aspect, the lowest estimated cost can be generated by comparing the costs for the plurality of plans. The costs for each plan can be generated independently of the set of probability-cost value pairs.

According to a second aspect of the disclosure, another method is provided. The method can be performed by a computer. The method includes, for each one of a plurality of specified database queries, generating a plurality of plans for potential execution by a DBMS. Each of the plurality of plans is configured, when executed by the DBMS, to generate a same response (in terms of the ultimate query result) to a same specified database of the plurality of specified database queries. The method further includes, for each one of a plurality of specified database queries, generating, for each plan of the plurality of plans, a set of probability-cost value pairs. Each probability-cost value pair is indicative of an estimated upper cost for its associated plan and a probability that a cost for said plan will be equal to or less than said estimated upper cost, if and when said plan is executed. The method further includes, for each one of the plurality of specified database queries, subsequently making a selection of: one or more of the plurality of specified database queries. The method further includes, for each selected one of the plurality of specified database queries, making a selection of a corresponding plan of the plurality of plans which implements the selected specified query of the plurality of database queries. The selection is based at least in part on an evaluation of the sets of probability-cost value pairs for the plurality of plans and for the plurality of specified database queries. The method further includes causing the DBMS to execute each selected query of the plurality of database queries using the corresponding plan of the plurality of plans.

In some embodiments of the second aspect, the selection may be further based on an indication of an upper cost threshold. In some embodiments of the second aspect, the plan selection may be further based on an indication that as many as possible of the plurality of specified database queries are to be completed while respecting the upper cost threshold. In some embodiments of the second aspect, making the selection includes selecting the one or more of the plurality of specified database queries. In some embodiments of the second aspect, making the selection further includes, for each selected one of the plurality of specified database queries, selecting the corresponding plan of the plurality of plans which implements the selected one or more queries of the plurality of database queries. Selecting the corresponding plan is such that the selection substantially maximizes a combination of: a number of the plurality of specified database queries which can be completed while respecting the upper cost threshold with a probability that meets or exceeds a specified probability level; and the specified probability level.

In some embodiments of the second aspect, the selection can be further based on an indication of an upper cost threshold. The selection can be further based on an indication that at least a specified portion of the plurality of specified database queries is to be completed while respecting the upper cost threshold. In some embodiments of the second aspect, making the selection includes selecting the one or more of the plurality of specified database queries. In some embodiments of the second aspect, making the selection further includes, for each selected one of the plurality of specified database queries, selecting the corresponding plan of the plurality of plans which implements the selected one of the plurality of database queries. The selection of the corresponding plan is such that the selection substantially maximizes a probability that at least the specified portion of the plurality of specified database queries will be completed while respecting the upper cost threshold.

A third aspect of the disclosure may provide for an apparatus including modules configured to perform the methods, according to the one or more aspects described herein.

According to a fourth aspect, an apparatus is provided, where the apparatus includes: a memory, configured to store a program; a processor, configured to execute the program stored in the memory, and when the program stored in the memory is executed, the processor is configured to perform the methods according to one or more aspects described herein.

According to a fifth aspect, a computer readable medium is provided, where the computer readable medium stores program code executed by a device, and the program code is used to perform the methods according to one or more aspects described herein.

According to a sixth aspect, a chip is provided, where the chip includes a processor and a data interface, and the processor reads, by using the data interface, an instruction stored in a memory, to perform the methods according to one or more aspects described herein.

Other aspects of the disclosure provide for apparatus, and systems configured to implement the methods according to the first aspect and other aspects disclosed herein. For example, wireless stations and access points can be configured with machine readable memory containing instructions, which when executed by the processors of these devices, configures the device to perform the methods according to one or more aspects described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a cardinality estimator, according to the prior art.

FIG. 2 illustrates a process for training a learned cost estimator, according to the prior art.

FIG. 3 illustrates cost estimation using a learned cost estimator, according to the prior art.

FIG. 4 illustrates a method of database query plan selection, according to an embodiment of the present disclosure.

FIG. 5A illustrates a procedure for constructing probabilistic cost information for a plan, according to an embodiment of the present disclosure.

FIG. 5B illustrates probability distributions based on a set of probability-interval pairs, according to an embodiment of the present disclosure.

FIG. 5C illustrates a plan selection based on probability cost distribution profiles of two query plans, according to an embodiment of the present disclosure.

FIG. 6 illustrates a risk attitude-based plan selector according to an embodiment of the present disclosure.

FIG. 7 illustrates an example of processing a query to generate and compare multiple query plans, and select and implement one query plan according to an embodiment of the present disclosure.

FIG. 8 illustrates a procedure for determining the order of multiple queries in a workload, and a plan for each query, according to an embodiment of the present disclosure.

FIG. 9 illustrates a procedure for determining the order of multiple queries in a workload, and a plan for each query, according to another embodiment of the present disclosure.

FIG. 10 illustrates a method for executing a single query, according to an embodiment of the present disclosure.

FIG. 11 illustrates a method for executing multiple queries, according to an embodiment of the present disclosure.

FIG. 12 is a schematic diagram of an electronic device that may perform any or all of operations of the above methods and features explicitly or implicitly described herein, according to different embodiments of the present invention.

It will be noted that throughout the appended drawings, like features are identified by like reference numerals.

### DETAILED DESCRIPTION

Database Management Systems (DBMSs), such as MySQL, PostgreSQL, Oracle, are widely used to organize, retrieve, and analyze data. Users can interact with a DBMS by entering queries. Given a query, multiple logically equivalent plans might exist which can be used to interact with the database in order to obtain the query results. To identify the plan with the lowest execution cost, the DBMS can use a component named the cost estimator. The cost estimator can operate to estimate the cost of each plan, and select the one plan with the minimal or least estimated cost to execute. The cost can be associated with overhead, runtime, memory usage, or the like, or a combination thereof.

As may be appreciated by a person skilled in the art, the performance of a DBMS can depend on the quality of its cost estimator. Using an inaccurate cost estimator can lead to selection of plans with high actual cost (e.g., runtime) as the execution plan, which can downgrade the performance of the DBMS. At a high level, existing cost estimators can be categorized into two groups: conventional cost estimators and learned cost estimators.

Conventional cost estimators mainly refer to statistics-based cost estimators which leverage necessary statistics such as the number of distinct values of a table column. Conventional cost estimators can estimate the cardinality (result size) of a (sub)query and compute the cost of a plan based on the estimated cardinality and system resource variables such as CPU speed. As may be appreciated by a person skilled in the art, a (sub)query can refer to a query that appears inside another query and may be implemented in support of that query.

Learned cost estimators, on the other hand, refer to methods which can use a machine learning (ML) model to map a plan to its cost. Learned cost estimators can potentially provide more accurate estimations across various datasets and scenarios.

DBMSs integrating conventional cost estimators maintain necessary statistics of the underlying data using structures. Such statistics may be presented for example as histograms. In an embodiment, conventional cost estimators can comprise a cardinality estimator which estimates the result size of a (sub)query using these statistics.

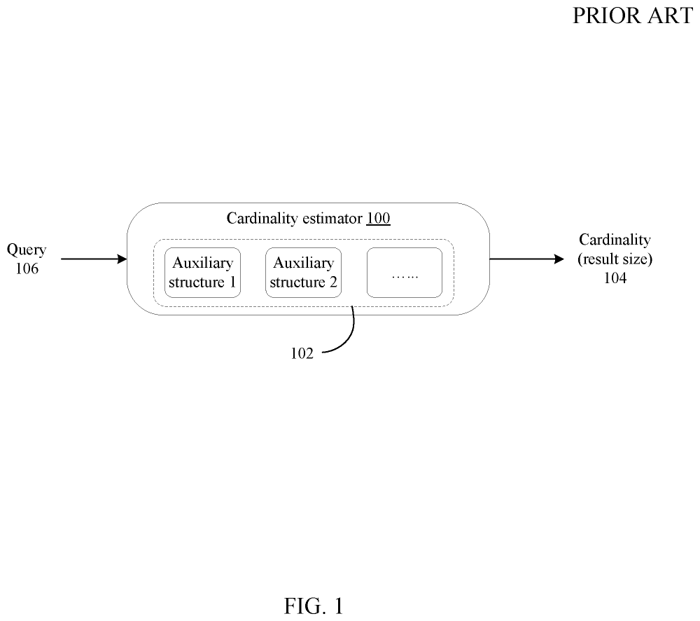

FIG. 1 illustrates a cardinality estimator. In an embodiment, the cardinality estimator 100 can comprise a plurality of auxiliary structures 102. Auxiliary structures may include histograms counting the number of tuples in a column (or multiple columns) that fall into particular value ranges, or synopses such as random tuples sampled from the underlying database on which the selectivity of a query is approximated, or the like. As illustrates, the cardinality estimator 100 can compute the cardinality (result size) 104 of a query 106.

Thereafter, the conventional cost estimator can compute (estimate) the cost of a given plan based on one or more of: system resource variable such as CPU and IO speed, the result size from the cardinality estimator, and other necessary information such as table width. This process can be repeated for multiple candidate plans, and the plan with the minimal or the least estimated cost can then be selected as the one used to implement or answer the query.

As mentioned, learned cost estimator can use machine learning techniques for cost estimation. In an embodiment, estimating the cost of a given plan is a typical regression task, with a plan being the input and the estimated cost being the output. A regression model can be trained such that given a plan, the estimated cost can be adequately close (e.g., as close as possible) to the actual cost of the corresponding plan.

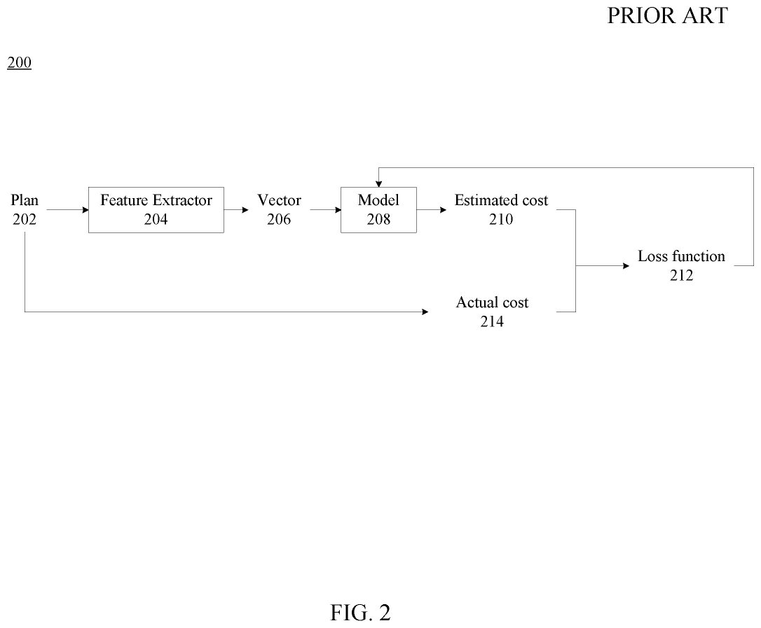

FIG. 2 illustrates a process for training a learned cost estimator. The process 200 can comprise providing a plan 202 to a feature extractor 204 to generate a vector 206. The process 200 can further comprise providing the vector 206 to a model 208 to generate an estimated cost 210. Thereafter, the estimated cost and the actual cost (e.g., runtime) 214 can be provided to a loss function 212 to generate outputs for updating the model 208. Accordingly, the model 208 can be trained to develop a learned cost estimator. A person skilled in the art may appreciate that appropriate feature extractor(s) 204 and loss function 212 can be used in the process 200. The process is in accordance with a typical machine learning process for training a model 208.

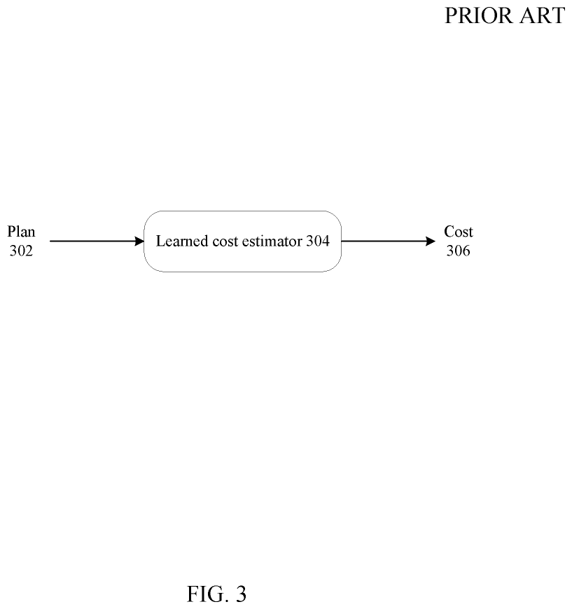

After the learned cost estimator is successfully trained, it can be used to estimate the cost of a given plan, according to, for example, FIG. 3. FIG. 3 illustrates cost estimation using a learned cost estimator. In an embodiment, a plan 302 can be provided to a learned cost estimator 304 to generate a cost 306. The learned cost estimator 304 can refer to the trained model 208 for example.

As may be appreciated by a person skilled in the art, learned cost estimator can be adaptive to the actual data, and thus, can provide a more accurate estimations than the conventional statistics-based cost estimators.

Although the problem of cost estimation has been studied for decades and various estimators have been designed, existing cost estimators can suffer from uncertainties. Uncertainties can quantify the possible amounts that the actual cost might differ from the estimated cost, and the probabilities of such differences occurring. Uncertainty is an a priori value determined before actual costs are observed. Uncertainty can be provided in the form of a probability distribution of similar set of probabilistic values, such as probability-cost value pairs. These uncertainties may lead to suboptimal or even catastrophic plan selection.

For example, assume plans A and B are two plans for implementing the same query. Estimated costs (in this example, runtimes) for plans A and B are 3 minutes and 5 minutes respectively. Since uncertainty exists, the actual costs for plans A and B may differ from the estimated costs. For example, the actual costs of plan A may be, for example 7 minutes and the actual cost for plan B may be 6 minutes. Accordingly, the errors (or deviations) denoting differences between estimated and observed actual costs are, respectively 4 minutes and 1 minute. Thus, choosing the plan with low estimated cost (e.g., plan A) may in practice lead to longer query processing time (actual cost being 7 minutes).

While uncertainty is almost impossible to avoid due to complexity of data and workloads, knowing such information can help identify plans whose performance is more trustworthy (i.e., having actual cost closer to the estimated cost), in addition to other potential benefits as described herein. Referring to the example described above, suppose, in a first scenario, the uncertainty of plan A is such that the probability of its error being 4 minutes or less is 80%, and the uncertainty of plan B is such that the probability of its error being 1 minute or less is also 80%. Comparing the uncertainty of plan A (maximum error of 4 minutes with 80% probability) with the uncertainty of plan B (maximum error of 1 minute with 80% probability), the more trustworthy plan can be determined to be plan B. Similarly, in a second scenario, the uncertainty of Plan A is such that probability of its error being 4 minutes or less is 90%, and the uncertainty of plan B is such that the probability of its error being 4 minute or less is 80%. Then, comparing the uncertainties of the plans in the second scenario, the more trustworthy plan can be determined to be plan A. Accordingly, trustworthiness of a plan (or the most trustworthy plan among a plurality of plans) can be determined based on the combination of the amount of deviation (between the estimated cost and the actual cost) and the probability of deviation.

As already mentioned above, and as may be appreciated by a person skilled in the art, in some embodiments, the cost of a plan can refer to the amount of time that a DBMS takes to execute said plan. Execution of a plan may refer to the operations performed by the DBMS in order to answer the query. This may include receiving the query and any additional information such as query hints, performing data retrieval and processing, and returning the results of the query. Thus, for example, the amount of time that a DBMS takes to execute a plan may refer to the amount of time the DBMS takes to return query results. More generally, the cost incurred to execute a plan may refer to the cost incurred (e.g., time, number of operations, combination thereof, etc.) by the DBMS in the process of returning query results. Trustworthiness can refer to predictability, e.g., in relation to the deviation in uncertainty, which describes how likely and how much the actual cost can deviate from the estimated cost. Notably, in embodiments of the present disclosure, rather than computing a probability distribution of predicate selectivity, a probability distribution over query costs is computed. A probability distribution type (e.g., uniform or beta) is not necessarily assumed.

While uncertainty is a common problem in DBMSs and uncertainty information can be helpful in plan selection, existing cost estimators typically only output a single value denoting the estimated cost without providing an indication of the uncertainty associated with the estimated cost.

Some techniques, such as the robust query optimizer, aim to quantify the “predictability” of cardinality estimation and balance between performance and predictability during plan selection. In such techniques, a high predictability can denote that the actual cardinality of the query might be closer to the estimated cardinality. These techniques involve maintaining random tuples from tables in the DBMS and running a given query on these random tuples. These techniques further involve computing the probability distribution for the query's actual selectivity based on observed selectivity from the random tuples using Bayes' rule. The probability distribution of the query's selectivity can be used interchangeably with cardinality.

A user can then specify a threshold a in range [0,1], and the a-th quantile (e.g., 30% quantile) of the query's selectivity distribution is used as its estimated selectivity. The cost of each plan is then computed based on the selectivity estimation corresponding to the α-th quantile. The plan with the lowest estimated cost is used as the execution plan. In these techniques, smaller a assigns higher weights to performance and plans with low costs, and thus plans with high uncertainty are preferred, while larger a assigns higher weights to predictability, and plans with low uncertainty are preferred. Although these techniques may consider the trade-off between query performance and uncertainty, these can suffer from problems that limit their application in modern advanced DBMSs.

For example, these techniques can make certain assumptions regarding the distribution of the selectivity, such as following a uniform or beta distribution, or require knowledge of the actual selectivity distribution. These assumptions and requirements can be impractical for many scenarios, as may appreciated by a person skilled in the arts. In addition, these techniques focus on quantifying the uncertainty of cardinality estimation and use such information to infer the uncertainty of cost estimation. However, such a strategy may only work with and be limited to conventional cost estimators which first map a query/plan to a cardinality and then to a cost value. Accordingly, these techniques may be not be applicable to learned cost estimators which directly map a plan to a cost value.

Embodiments described herein may address the challenge of quantifying the uncertainty of a given cost estimation and leverage such information for trustworthy plan selection. Embodiments described herein may further leverage the uncertainty information by allowing a DBMS user to specify a “risk attitude” based on the uncertainty information to participate in the plan selection process. In some embodiments, risk attitude may refer to a user-generated preference between plans with low cost and low uncertainty when there is a conflict.

Embodiments described herein may (for example precisely or relatively precisely) quantify the uncertainty of a particular cost estimation. Various embodiments may achieve this substantially regardless of the query complexity, data distribution, estimator type (conventional estimator or learned estimator), or a combination thereof. Embodiments described herein may facilitate uncertainty-aware plan selection and identify plans that are more trustworthy by integrating the uncertainty information into the plan selection strategy.

Embodiments described herein may further allow a user to participate in the plan selection process. For example, in some embodiments, a DBMS user may be presented with the uncertainty information, the user can select a plan based a desired level of uncertainty, or a combination thereof. In some embodiments, the user can customize their “risk attitude” during the plan selection process. For example, the user may indicate a user-generated preference between low cost and low uncertainty when a conflict (or choice) between the two arises.

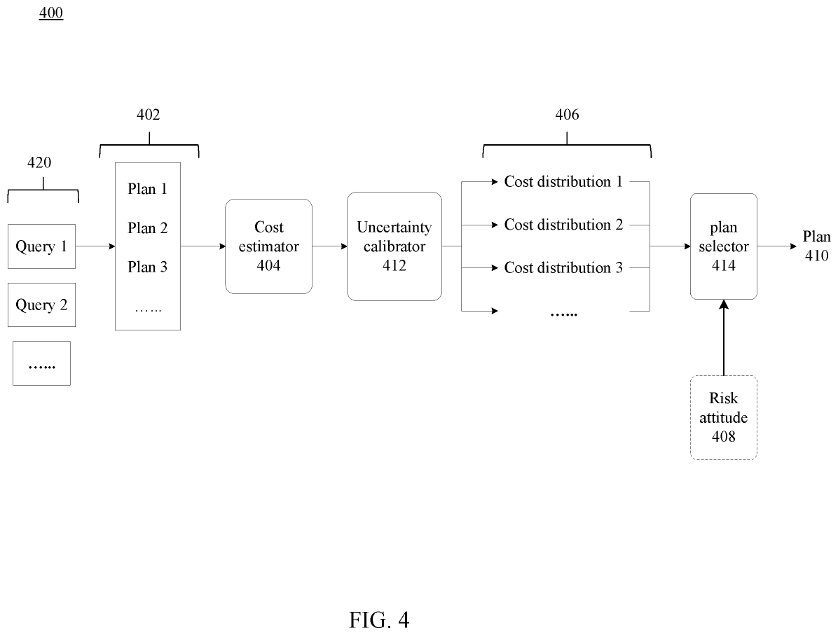

Embodiments described herein may provide for a method of database query plan selection. FIG. 4 illustrates a method of database query plan selection, according to an embodiment of the present disclosure. The method 400 may comprise generating a plurality of plans 402 for potential execution by a DBMS, each of the plurality of plans 402 being configured, when executed by the DBMS, to generate a same response to a same specific database query (e.g., query 1 of a plurality of queries 420). Each of the plans may be considered to be equivalent in terms of the ultimate query response which it generates. A plan generator may be used to generate the plurality of plans 402. The plan generator may be configured in a conventional manner as would be readily understood by a worker skilled in the art.

The method 400 may further comprise generating, for each plan of the plurality of plans 402 a cost distribution comprising a set of probability-cost value pairs. In an embodiment, a cost estimator 404 may be calibrated to quantify uncertainty associated with each of the plurality of plans 402. The uncertainty calibrator 412, which receives output from the cost estimator 404, may leverage statistical tool(s), such as conformal technique(s), to construct cost distributions 406 corresponding to the plurality of plans 402. The cost estimator 404 may be a conventional cost estimator or a learned cost estimator. In some embodiments, the uncertainty calibrator can include the cost estimator as a component thereof.

As will be readily understood by a worker skilled in the art, a conventional cost estimator or a learned cost estimator typically only outputs a single estimated cost associated with an input plan. The uncertainty calibrator 412 is configured to generate cost distributions at least in part using output of the cost estimator. The cost distributions include multiple estimated (e.g., upper) costs associated with an input plan, along with associated probability information, such as the cost distribution comprising probability-cost value pairs.

In an embodiment, each probability-cost value pair of the set of probability-cost value pairs may indicate, as one of the values in the pair, an estimated upper cost for associated plan and, as the other value in the pair, a probability that an actual incurred cost for said plan will be equal to or less than said estimated upper cost, if and when the plan is executed. Accordingly, embodiments may provide additional information (i.e., a quantification of uncertainty) in addition to an estimated cost (e.g., an estimated runtime of the plan). For example, the probability-cost value pair (p,v) may be interpreted as an indication that with probability p, the cost of implementing the plan is expected to not exceed v. Estimated upper costs (such as estimated maximum amounts of time) are thus associated with respective probabilities that the estimated upper costs will be respected (i.e., actual cost will be less than or equal to the estimated upper cost).

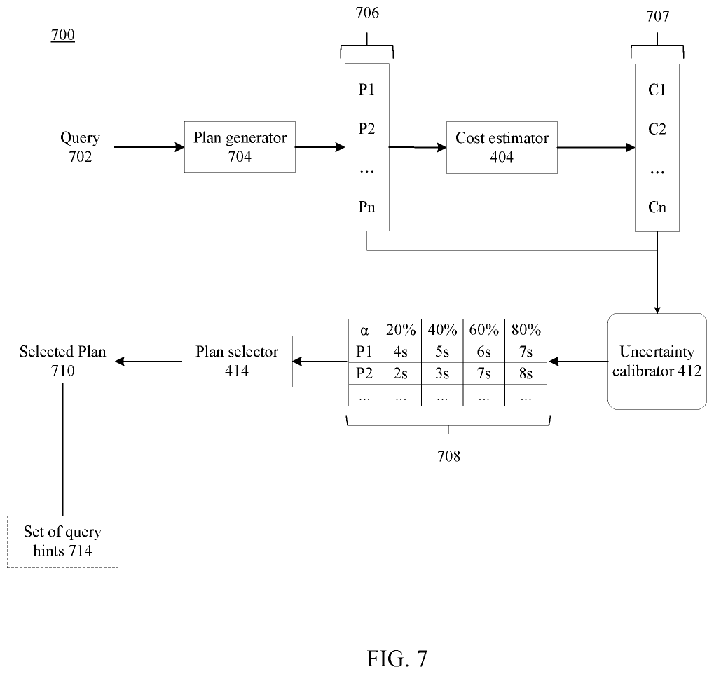

The method 400 may further include selecting, via a plan selector 414, a plan 410 from the plurality of plans 402 based at least in part on an evaluation of the set of probability-cost value pairs (e.g., cost distributions 406) for the plurality of plans. The evaluation may involve a comparison between multiple ones of the probability-cost value pairs, the comparison being made based on a particular criterion. The criterion can depend on certain preferences, such as user preferences. Depending on the criterion, the evaluation can be made based on a comparison of the probability values, the cost values, or a combination thereof. For example, referring to the table 708 in FIG. 7, and as explained later herein, the criterion may be that the plan should be plan which is most likely to finish within 7 seconds. Based on the table 708, the probability of P1 finishing within 7 seconds is 80%, while the probability of P2 finishing within 7 seconds is 60%, and thus P1 may be selected.

The method 400 may further include causing the DBMS to execute the selected plan 410, for example by determining and providing appropriate query hints to the DBMS. Causing the DBMS to execute the selected plan may further involve submitting the query to the DBMS. Causing the DBMS to execute the selected plan may further involve submitting auxiliary information (such as the query hints) to the DBMS in order to influence it to execute the selected plan, as will be readily understood by a worker skilled in the art.

In some embodiments, the selection of the plan 410 can be based on a risk attitude (user-generated preference) 408 of the user. Accordingly, embodiments may allow a user to customize their risk attitude, and based the user's risk attitude, a plan 410 may be selected based on an evaluation of the user's risk attitude in combination with the cost distributions 406. Accordingly, the selected plan 410 may be the plan, among the plans 402, that best satisfies the user's risk attitude.

In some embodiments, the user can indicate their risk attitude based one or more of: a time threshold for a single query or workload, a percentile constraint for a workload, and a preference between an interaction mode (first mode) and an execution mode (second mode). These thresholds, constraints and modes are described elsewhere herein.

Embodiments described herein may provide for constructing or generating cost distributions 406. In an embodiment, the cost estimator 404 can be calibrated such that for a given plan, the uncertainty calibrator (which includes or is associated with the cost estimator) can output a cost distribution corresponding to the plan. In this sense, “calibration” may refer to “wrapping” (e.g., augmenting) the cost estimator with the conformal techniques so that the estimation error of the estimator can be quantified. The estimation error may then be used to construct the cost distribution related to the uncertainty information. In some embodiments, conformal techniques can be used in coordination with the cost estimator 404 and related parameters can be varied to construct the cost distributions 406. As may be appreciated by a person skilled in the art, conformal techniques may refer to statistical tools designed to quantify the uncertainty of regression models. In constructing cost distributions, some embodiments may assume that the cost estimator is already provided (e.g., as a conventional or machine learning based cost estimator) and the query workload is available.

In some embodiments, prior to generating the cost distributions, one or more conformal techniques may be initialized. The initialization may be performed based on a plurality of examples. A person skilled in the art may know of the various conformal techniques which can be initialized before deployment. In an embodiment, initializing a conformal technique can comprise providing a device operating the conformal technique with a set tuples each reflecting an instance of: a plan, the estimated cost of the plan and the actual incurred cost of the plan. The more tuples provided to the device, the better the conformal technique can provide cost estimates for additional plan inputs.

In some embodiments, as part of initializing the conformal technique, a probability level a (e.g., 90%) can be specified for the conformal technique, and the conformal technique can then be operated capture a mapping from a plan (fed as an input into the conformal technique) to its error or deviation (the absolute difference between the estimated cost and actual cost). The more tuples are fed into the conformal technique, the more accurate the captured mapping can be.

Accordingly, in an embodiment, a result of the conformal technique initialization is that, given a substantially arbitrary plan, the conformal technique is configured to predict the uncertainty of the cost estimator's output (estimated cost) for that plan. In some embodiments, the uncertainty of the cost estimator's estimation can be an interval which is output by the conformal technique. In some embodiments, the interval can be in the format, for example, “with probability α, the actual cost is expected to fall within an interval (C−τ, C+τ), where C is the average estimated cost (e.g., as provided by the cost estimator).

In some embodiments, in order to generate the cost distributions, the cost estimator can be wrapped with the conformal technique. As mentioned above, conformal technique can assign an interval to each cost estimate, indicating the cost range into which the cost is expected to fall under the specified probability level a. Accordingly, by varying the value of the specified probability level a (e.g., 90%, 80%, 70%, etc.), embodiments can construct multiple corresponding cost ranges (intervals) for a given cost estimate. This can be used to form a cost distribution of the corresponding plan.

It is noted that, in the above, an estimated cost C is generated. This estimated cost is provided as an input to the conformal technique. The estimated cost can be generated by a cost estimator such as cost estimator 404. The conformal technique operates based in part on this estimated cost, and thus generating probability-cost value pairs involves generating estimated costs as a starting point.

In various embodiments, the upper bound of the cost range (interval) provided by the conformal technique, along with the specified probability level resulting in that cost range, can be provided as a probability-cost value pair, as described elsewhere herein.

The conformal technique can be implemented by an estimation module. The estimation module may receive the probability level a and invoke the conformal technique as describe above to provide a cost range, or at least an upper bound of the cost range. That is, the estimation module may provide a cost value such that, with probability a, an expected cost incurred by the plan will be less than or equal to the cost value.

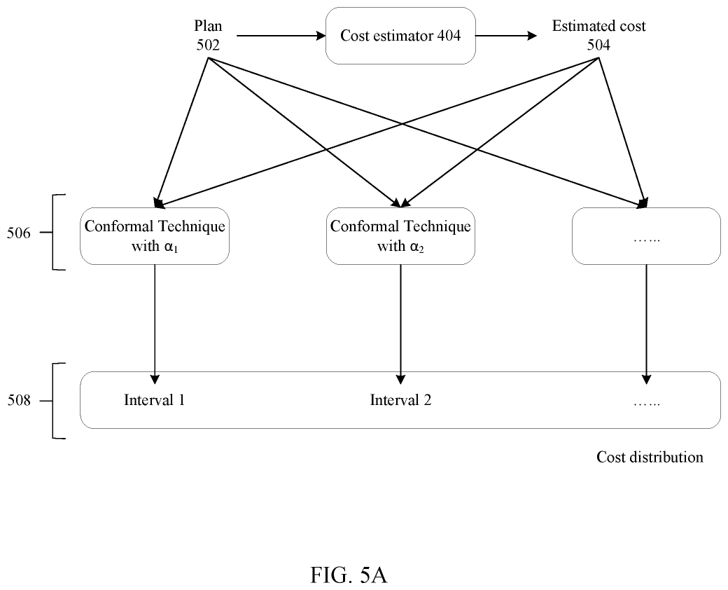

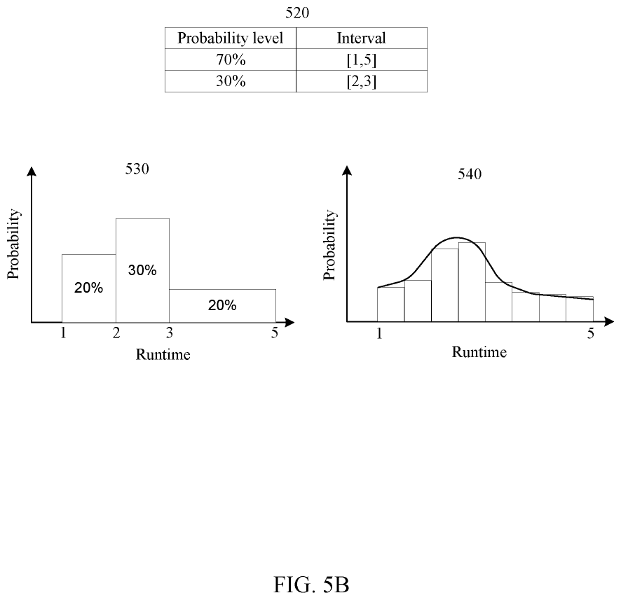

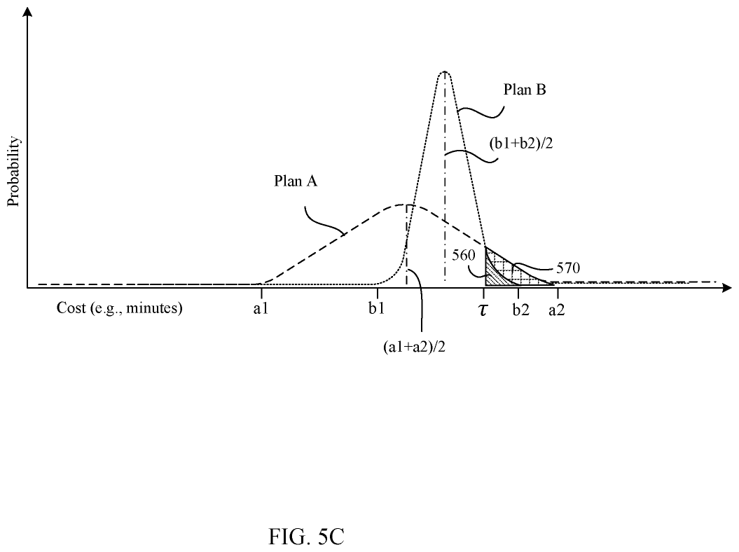

FIG. 5A illustrates a procedure for constructing probabilistic cost information for a plan, according to an embodiment of the present disclosure. In an embodiment, a plan 502 (for a given query) can be fed into a cost estimator 404 to generate an estimated cost 504. Thereafter, conformal techniques 506 (e.g., device(s) operating the conformal technique(s)) can be provided with one or more probability levels α, along with the plan 502 and the estimated cost 504. As shown, the conformal technique is provided with at least two probability levels α₁ and α₂. For each of the one or more probability levels α, the conformal technique may be configured to indicate an interval. The interpretation is that, with the specified probability level a, the actual cost (e.g., runtime) of the plan 502 is expected to fall within the interval. Accordingly, a cost distribution 508, which is a probabilistic set of values, can be determined based on the generated one or more intervals as illustrated. Embodiment of FIG. 5A may correspond to generation of cost distributions 406 of FIG. 4. In some embodiments, rather than intervals, the conformal techniques can return maximum costs only, i.e., upper bounds of the interval. In some embodiments, based on the intervals, probability-cost value pairs can be generated, for example by indicating the upper bound of the interval as the cost portion of the pair and the associated probability level a as the probability portion of the pair. The cost distribution may comprise a plurality of such probability-cost value pairs.

It is noted that, in embodiments, if enough probability-interval pairs are computed, a cost distribution (as mentioned above) can be generated. A probability-interval pair refers to an interval in which the cost may fall (e.g. between a minimum and a maximum) along with an associated probability of the cost falling within this interval. Suppose that a first probability-interval pair indicates that the probability of the runtime falling into interval [l1,u1] is 1−α1, and a second probability-interval pair indicates that the probability of the runtime falling into interval [l2,u2] is 1−α2, and α1<α2. Then the probabilities of falling in intervals [l1, 12] or [u2,u1] are both (α2−α1)/2. Using more α values can provide for more fine-grained distributions as described in reference to FIG. 5B.

FIG. 5B illustrates probability distributions based on a set of probability-interval pairs, according to an embodiment of the present disclosure. In an embodiment, a set of probability-interval pairs can be indicated according to table 520. The interpretation of the table is that, with a specified probability, the cost will fall within a specified interval. Based on the set of the probability-interval pairs, fine-grained distributions can be determined, for example, as represented by histogram 530 and plot distribution 540. An illustrative example of generating fine-grained distributions can be as follows. Referring to table 520, the first probability-interval pair in the table can be written as probability (70%=1−α1) and interval [l1, u1]=[l, 5]. Thus α1 can be determined to be 0.3.

Similarly, the second probability-interval pair in table 520 can be written as probability (30%=1−α2) and interval [l2, u2]=[2, 3]. Thus, α2 can be determined to be 0.7. Provided that α1<α2, l1<l2, and u2<u1, then the probabilities of runtime falling in intervals [l1, l2] or [u2, u1] can be determined according to (α2−α1)/2. Determining these intervals and their corresponding probabilities may be as follows: [l1, l2]=[l, 2], [u2, u1]=[3, 5], and (α2−α1)/2=(0.7−0.3)/2=0.2. Accordingly, two additional probability-interval pairs can be determined based on the first and second probability-interval pairs in table 520. Respectively, the two additional probability-interval pairs may be a third probability-interval pair indicating that the probability of the runtime falling into interval [l, 2] is 20%, and a fourth probability-interval pair indicating that the probability of runtime falling into interval [3, 5] is also 20%. These determined probability-interval pairs can then be used to generate a histogram, e.g., histogram 530.

Further additional probability-interval pairs, using a as described, can be determined to generate more fine-grained distribution as illustrated in the plot distribution 540.

Embodiments described herein may provide for an enhanced procedure for cost estimation based on conformal technique. Embodiments may further use conformal technique(s) to quantify the uncertainty of a regression model. In some embodiments, the quantification can be performed in the absence of impractical assumption of the data distribution and workload patterns.

Embodiments described herein may further use the uncertainty calibrator 412 to construct a cost distribution for a plan (of a plurality of plans associated with a query). The cost distribution may provide a more comprehensive and accurate description of the plan's potential outcome (e.g., in terms of expectations of cost incurred) and facilitate the selection of more trustworthy plans.

Embodiment described herein may provide for leveraging uncertainty information for plan selection. The uncertainty information may be in the form of probability-cost value pairs, intervals into which costs are expected to fall with associated probabilities, probability distributions for expected costs, or the like, or a combination thereof. Embodiments described herein may further provide for allowing a user to participate in the plan selection process by customizing risk attitudes to balance between plans with low cost and plans with low uncertainty (e.g. low variance in the underlying probability distribution).

Given the cost distribution of candidate plans, a DBMS user may prefer plans with different profiles (e.g., shapes of probability distribution of cost). This preference may be based on the user's requirements, preferences or constraints. Accordingly, embodiments may provide for a user to customize their risk attitudes, by allowing the user to indicate one or more requirements, preferences, constraints, or combination thereof. Embodiments may be configured to make a plan selection that can be based on the cost distributions and user indicated requirements.

For example, referring to FIG. 5C, Plan A has a cost distribution ranging from α1 to α2 with a mean equal to (α1+α2)/2, and Plan B has a cost distribution ranging from b1 to b2 with a mean equal to (b1+b2)/2 which is higher than the mean of Plan A as illustrated. Plan B has lower variance than Plan A. Suppose a user wants to complete query execution with maximum cost τ. In such a case, Plan B is preferred as the probability of exceeding τ under Plan B (e.g., where probability can be represented as the area 560 under cost distribution of Plan B between τ and b2) is smaller than the probability of exceeding τ under Plan A (e.g., where probability can be represented as the area 560+570 under cost distribution of Plan A between τ and α2) as illustrated. In other words, Plan B is preferred as the probability that the cost will be less that τ is higher under Plan B than under Plan A.

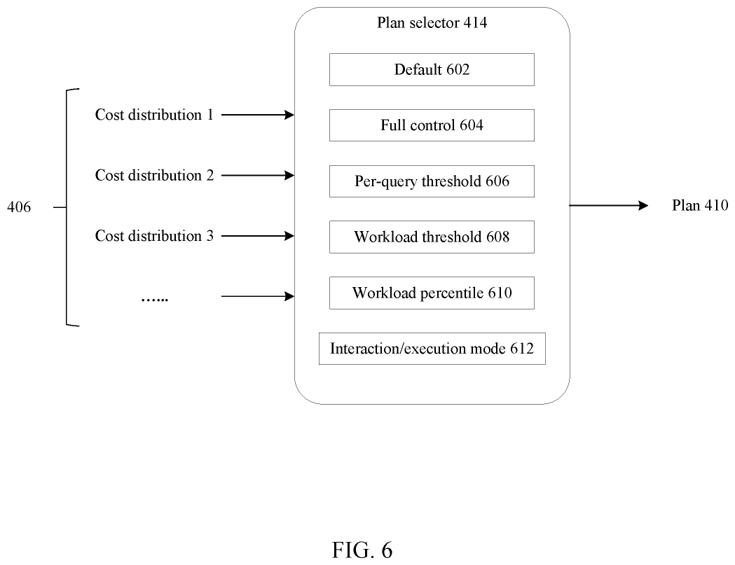

FIG. 6 illustrates a risk attitude-based (user-generated preference-based) plan selector 414 according to an embodiment of the present disclosure. The plan selector 414 can select a plan based on different modes. For example, the plan selector 414 can select a plan based on (i.e., while operating in) a default mode 602. The default mode 602 may indicate that a plan is to be selected based on minimal estimated cost. The default mode may be activated when, for example, the user does not indicate any constraints. The modes can be selected by a user as user-generated preferences.

In some embodiments, the plan selector 414 can select a plan based on a full control mode 604. Under the full control mode 604, a user may be presented with cost distributions (e.g., cost distributions 406 such as associated probability-cost-value pairs) of all plans (e.g., plurality of plans 402), and the user can select a plan (e.g., plan 410) based on their own preferences, which may reflect risk attitude. Accordingly, embodiments may provide a user with control and flexibility to select a desired plan, at the cost of extra user effort in analyzing costs distributions or related data. Such embodiments may be applicable to queries the performance of which is critical.

In some embodiment, the plan selection can be based on a per-query threshold 606. For example, a user may specify or indicate a maximum cost threshold for a single query (e.g., 2 minutes). The maximum cost threshold may indicate a need for the query results to be returned without invoking costs beyond the maximum cost threshold (e.g., the query results should be returned within two minutes). Accordingly, the plan selector 414 may select a plan which returns results with a lowest probability of exceeding the maximum cost threshold, presuming such a plan is available. In other words, the selected plan can be the plan which has a highest probability of the cost being less than or equal to the maximum cost threshold, which is also referred to as a maximum acceptable single query cost. Further, the maximum cost threshold can be user-generated or more generally can be based on a user-generated preference.

In some embodiments, a query workload (a batch of multiple queries) is considered rather than a single query, and plan selection is made for some (or all) queries in the workload. In these embodiments, for each of a plurality of queries in the batch, plan generation and generation of probability-cost value pairs proceeds in the same general manner as specified above for the single query case. Then, one or more of the queries are selected, and for each of the selected queries, a corresponding plan is selected. The query selection and the plan selection is based at least in part on an evaluation of the sets of probability-cost value pairs that have been generated. Finally, the DBMS is caused to execute the selected queries and plans, by submitting the queries (e.g., in sequence, concurrently, or a combination thereof) to the database along with ‘hints’ or other applicable means for influencing the DBMS.

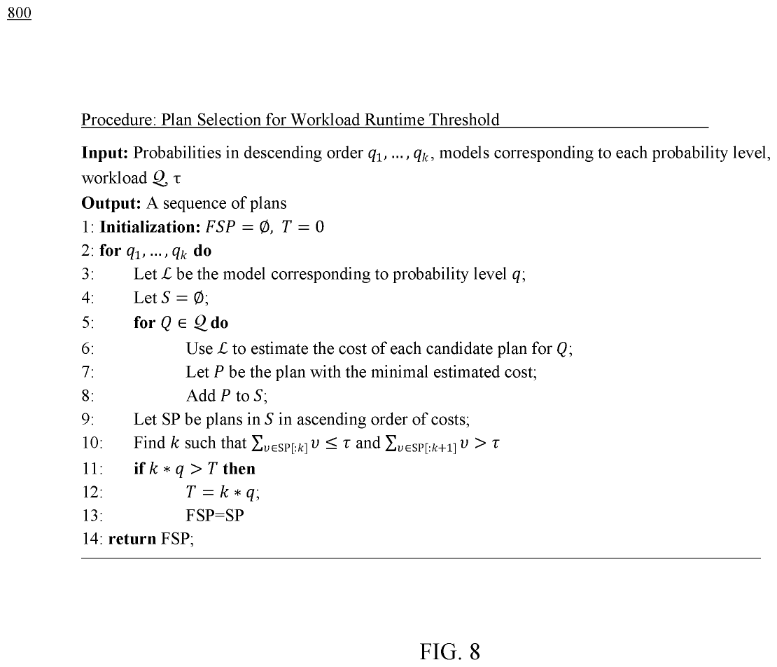

In some embodiments, the plan selection can be based on a query workload threshold criterion 608. For example, a user can indicate a threshold for a workload (i.e., a batch of queries) and the plan selection can be based on the objective to finish as many queries as possible while attempting (with adequate probability) to maintain costs at or below the specified threshold. Further details of embodiments of the query workload threshold criterion will be presented elsewhere herein, for example with respect to FIG. 8.

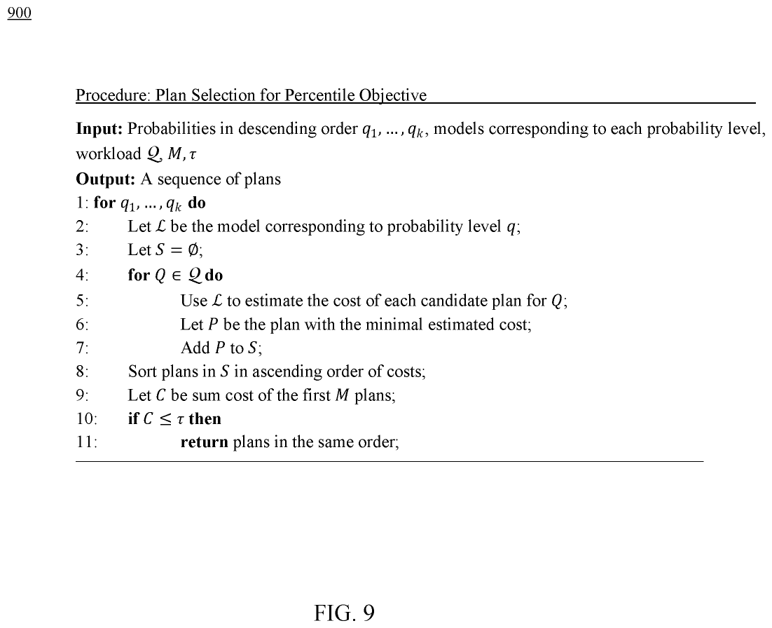

In some embodiments, plan selection can be based on a query workload percentile criterion 610. For example, a user can indicate a percentage x and a duration t, and the plan selector 414 can select a plan such that, for a workload, with adequate probability, at least x % queries will be finished within duration t. Further details of embodiments of the query workload percentile criterion will be presented elsewhere herein, for example with respect to FIG. 9.

In some embodiments, plan selection can be based on an indication of whether plan selection is to proceed according to either an interaction mode or an execution mode 612. In some embodiments, a user can switch between an interaction mode and an execution mode for query processing, in order to provide such an indication, by indicating which of these modes should be used via a user-generated preference. In the interaction mode, the user may indicate a desire to avoid long-running plans and thus a preference is made for queries with low uncertainty. That is, the user may indicate that more certainty in cost is preferred rather than lower cost. In the execution mode, the user may indicate a concern with the overall cost (e.g., runtime) of a query batch, and thus the user may prefer plans with low cost. In some embodiments, the interaction mode and the execution mode can be provided as separate options for independent selection. Operation in the interaction mode is described elsewhere herein.

Accordingly, embodiments may provide for selection of a plan based on one or more of user preferences and cost distribution, such that the selected plan is the most desired plan for each query. In some embodiments, a user can adopt any available option to specify one or more requirements.

Embodiment described herein may leverage the cost distribution information by allowing a user to indicate their requirements during the plan selection process. In some embodiments, the behavior of a query or a workload can be predictable and controllable, which may provide a more trustworthy DBMS performance. Further, embodiments may allow for users' requirements to be fulfilled in various scenarios regarding query processing, which may further provide flexibility to users in selecting plans for ad-hoc tasks.

Embodiments described herein may provide for generating cost distributions for query plans by using conformal techniques to calibrate cost estimators (which may include both conventional and learned cost estimators). Embodiments may further provide for various options for a user to indicate risk attitudes and requirements regarding query performance. Embodiments may further provide for selecting query plans according to user's risk attitudes and requirements.

FIG. 7 illustrates an example of processing a query to generate and compare multiple query plans, and select and implement one query plan according to an embodiment of the present disclosure. Processing a query may involve a plan generator 704, a cost estimator 404, the uncertainty calibrator 412, and the plan selector 414. In an embodiment, a user (or other source) may indicate a query 702 for processing. The processing 700 may comprise passing the query 702 to a plan generator 704 which is configured to obtain (e.g. generate) several logically equivalent plans 706 to implement the query, the plans denoted by P1, P2, . . . , Pn. These plans 706 may read the database tables involved in query 702 in different orders, or use various scan operators (e.g., sequential scan, index scan) or join operators (e.g., merge join, hash join, nested loop), but they all provide the same results if executed by the DBMS.

In some embodiments, the processing 700 may further include passing the plans 706 (e.g., P1, P2, Pn) to the cost estimator 404. The cost estimator 404 can provide cost information 707 for each plan. For example, the cost estimator may predict that finishing P1 takes 6 seconds, finishing P2 takes 7 seconds, etc. The cost estimator may be a conventional cost estimator or machine learning based cost estimator, and may return a single cost value for each plan provided thereto.

In some embodiments, the processing 700 may further include providing each plan together with its estimated cost to the uncertainty calibrator 412. The uncertainty calibrator 412 can assign multiple cost intervals to each plan based on its characteristics (such as which tables/attributes/tuples are involved, which scan/join operators are involved, the join order, etc.) and estimated cost. Each interval of the multiple intervals can be based on a different respective probability level a. The uncertainty calibrator accordingly can output a cost distribution such as the distribution table 708. Referring to the distribution table 708, where probability level a is 20% and 40%, P2 can process the query 702 fast than P1. However, where probability level a is 60% and 80%, P1 can process the query 702 faster than P2. The distribution table indicates multiple probability-cost value pairs. For example, the pair (20%, 4s) indicates that with probability 20%, P1 can process the query in under 4 seconds, the pair (40%, 3s) indicates that with probability 40%, P2 can process the query in under 3 seconds, etc.

In some embodiments, the processing 700 may further include inputting the cost distribution (e.g., the distribution table 708) (or associated probability-cost value pairs) to a plan selector 414, which integrates the user's preference about query performance. For example, the user may prefer a plan that is likely to finish within 7 seconds. Based on the distribution table, the probability of P1 finishing within 7 seconds is 80%, while the probability of P2 finishing within 7 seconds is 60%, and thus P1 may be more desired and thus be selected. The user can also specify other preferences as described elsewhere herein. The plan selector outputs a selected plan 710.

Suppose that P1 is the plan that is preferred by the DBMS user. In an embodiment, P1 may be transferred to a set of “query hints” describing the join order, join operator types, and scan operator types of P1. The set of query hints may then be fed to the DBMS. This providing of the set of query hints may be performed as part of causing the DBMS to execute a selected plan. As may be appreciated by a person skilled in the art, hint is a feature supported by most DBMS for the user to specify which plan(s) are desired. Accordingly, the query 702 can then be passed to the DBMS and the DBMS would choose P1 as the execution plan. More generally, a set of query hints 714 can be provided to the DBMS, e.g., by the plan selector, where the query hints 714 cause, or tend to cause, the DBMS to implement the selected plan 710.

In some embodiments, plan selection can be based on a workload Q, i.e., a batch of queries, such that the plan selection is based on finishing as many queries as possible while respecting an upper cost threshold. For example, when the cost is time-based, the plan selection may be based on finishing as many queries as possible within a duration or amount of time τ. That is, a batch of queries is presented, and a subset of the batch of queries is selected, and, for each query of the subset, a plan is selected, where the subset and the corresponding plans satisfy the objective. Such an objective can be denoted, for example, by a workload runtime threshold. Because the cost distributions (e.g., 406, 508, and 708) can describe the runtimes in a probabilistic way, the exact number of queries that can be finished while respecting the upper cost threshold (e.g., within a certain duration τ) may not be possible to be known. However, embodiments may provide for an increased expected number of queries to finish while respecting the upper cost threshold.

Accordingly, in an embodiment, the workload runtime threshold objective can be formalized by modelling it as an integer programming problem, thereby, obtaining a simple, yet intuitive plan selection heuristic which may solve the optimization problem.

Considering a particular query Qᵢ, nᵢ may represent the different potential plans for Qᵢ, and vᵢ^{j}˜Dᵢ^{j} may denote the runtime of the j-th plan (j∈[1, nᵢ]), where Dᵢ^{j} may be the corresponding runtime distribution. That is, vᵢ^{j} is a random variable with probability distribution Dᵢ^{j}. A vector Vᵢ=[vᵢ¹, vᵢ², . . . , vᵢⁿ^{ᵢ}] can be used to organize all the runtime variables of Qᵢ's plans. Let Cᵢ to be a binary vector, with Cᵢ [j] being 1 if the j-th plan is selected as the execution plan for Qᵢ and all other bits being 0. Thus, increasing the probability that the workload can be finished while respecting the given threshold T may be based on solving the following optimization problem:

Maximize ∫ . . . ∫ₜ_{₁}_{, . . . ,t}_{ₘ}_{∈(0,τ)}|S_{τ}(t₁, . . . ,tₘ)|X

Π_{i∈S}_{_{τ}}₍ₜ_{₁}_{, . . . ,t}_{ₘ})P(Cᵢ·Vᵢ^{T}≤tᵢ)dt₁. . . dtₘ;

Subject to ∀ᵢ∈[1,m],Cᵢ^{T}Cᵢ=1 (1)
where S_{τ}(t₁, . . . , tₘ)⊆{1, . . . , m}, Σ_{i∈S}_{_{τ}}₍ₜ_{₁}_{, . . . , t}_{ₘ}₎tᵢ≤τ, and ∀S s.t. S⊆{1, . . . , m}∧τ_{i∈S}tᵢ≤τ, |S_{τ}(1, . . . , m)|≥|S|. In other words, S_{τ}(t₁, . . . , tₘ) is the maximal set of subscripts in range [1, m] such that the sum of values in {t₁, . . . , tₘ} indexed by these subscripts does not exceed τ.

The constraint of Equation (1) may ensure selection of one plan for each query. In an embodiment, each selected plan Pᵢ can be assigned a “local” cost (e.g. time) threshold tᵢ denoting the maximal cost that the plan should incur, e.g. the amount of time the plan should finish within. To finish more plans within τ, in an embodiment, plans associated with smaller tᵢ can be executed first.

For a particular configuration of local thresholds, t₁, . . . , tₘ, only the plans indexed by S_{τ}(t₁, . . . , tₘ) might be considered as these queries are expected to be the lowest cost (e.g., fastest) and adding any of the remaining plans may violate the overall threshold constraint. The probability that plans indexed by S_{τ}(t₁, . . . , tₘ) can finish while respecting their corresponding local threshold can be computed as Π_{i∈S}_{_{τ}}₍ₜ_{₁}_{, . . . , t}_{ₘ}₎ P(Cᵢ·Vᵢ^{T}≤tᵢ), and the expected number of plans that can be finished while respecting τ is thus |S_{τ}(t₁, . . . , tₘ)|×Π_{i∈S}_{_{τ}}₍ₜ_{₁}_{, . . . , t}_{ₘ}₎ P(Cᵢ·Vᵢ^{T}≤tᵢ).

The target is to select the best plan for each query (choosing Cᵢ) such that the expected number of plans that can be finished while respecting i across all possible configurations of local thresholds can be maximized.

Optimizing Equation (27) can be viewed as an integer programming problem (choosing a plan identifier (ID) for each query) which is known to be NP-complete. Since enumerating all plan combinations can be expensive and exhausting, embodiments may provide for an efficient and effective heuristic for plan selection.

In order to maximize the expected number of plans finished within τ, two questions need to be answered: (1) in what order should the queries be processed, and (2) which plan should be chosen for each query. The procedure 800 illustrated in FIG. 8 may provide for answering the two questions simultaneously. FIG. 8 illustrates a procedure for determining the order of multiple queries in a workload, and a plan for each query, according to an embodiment of the present disclosure.

In embodiments of FIG. 8, estimators under probability levels q₁, q₂, . . . , qₖ (sorted in descending order) is assumed to have been constructed (referring to input). The model corresponding to probability q₁ can be used to estimate the cost of each candidate plan of queries in the workload Q and select the plan with the minimal estimated cost for each query. The selected plans can be sorted in ascending order of their costs (so that plans with low costs can be executed first). The number of plans (assumed to be k) that can finish within τ, can be counted. Since with the current probability level, only q (in percentage) plans could finish while respecting their estimated costs (e.g., within their estimated runtimes), in an embodiment, the expected number of plans that can finish while respecting τ thus can be approximated as k*q. By traversing over all probability levels, the collection of plans that lead to the maximal expected number of plans that could finish while respecting τ can be determined.

In some embodiments, plan selection can be based on a workload percentile objective. For example, given a workload of m queries, labeled Q₁, . . . , Qₘ, the objective may be that at least M (M∈[1, m]) queries are to be processed or finished. A person skilled in the art may appreciate that determining whether a provided percentile objective can be satisfied or not may not be possible. However, embodiments may provide for increasing the probability that the percentile objective can be satisfied.

In an embodiment, the workload percentile objective can be modeled as an integer programming problem, and notations defined herein can be reused including Cᵢ and Vᵢ. Accordingly, increasing the probability that the at least M queries can be finished within the given threshold τ may be based on solving the following optimization problem:

$$Maximize \int … {\int }_{\begin{matrix}{t}_{1} , … , {t}_{m} \geq 0 \\ {t}_{1} + ⋯ + {t}_{m} = τ\end{matrix}} {\prod }_{i = 1}^{m} P ( {C}_{i} \cdot {V}_{i}^{T} \leq {t}_{i} ) {dt}_{1} … {dt}_{m} \qquad ( 2 )$$

$$Subject to {∀}_{i} ∈ [ 1 , m ] ,$$

$${C}_{i}^{T} {C}_{i} ∈ \{ 0 , 1 \} ,$$

$$and$$

$${\sum }_{i = 1}^{m} {C}_{i}^{T} {C}_{i} = M$$

The constraint of Equation (2) may ensure that at most one plan is selected for each query (Cᵢ^{T}Cᵢ∈{0,1}), and the total number of selected plans may be M ((Σ_{i=1}\hat{ }m C_i\hat{ }T C_i=M). For the other m-M queries, a substantially arbitrary metric for plan selection may be adopted, and these queries can be executed after the M plans selected by Equation (2), thereby not influencing the probability that the percentile goal can be satisfied.

The objective of Equation (2) can be described as follows. If a plan is selected for query Qᵢ, a “local” threshold tᵢ can be assigned to the plan and the probability that the selected plan finishes within tᵢ can be computed. The computation for all queries may be conducted and summation of all local thresholds up to τ can be ensured. Thus, the integral over all possible combinations of local thresholds can be the probability to satisfy the percentile objective of the workload.

Since solving Equation (2) can be equivalent to answering an integer programming problem (choosing a plan ID for each query), a heuristic for plan selection can be designed. In an embodiment, a procedure 900 is provided that may determine the processing order of the queries and which execution plan to use for each query. FIG. 9 illustrates a procedure for determining the order of multiple queries in a workload, and a plan for each query, according to another embodiment of the present disclosure.

In embodiments of FIG. 9, estimators under probability levels q₁, q₂, . . . , qₖ (sorted in descending order) can be assumed to have been constructed. In an embodiment, the model corresponding to probability q₁ can be used to estimate the cost of each candidate plan of queries in the workload and the plan with the minimal estimated cost for each query can be selected. The selected plans can be sorted in ascending order of their costs (so that plans with low costs can be executed first, to maximize the probability to satisfy the objective).

If the sum cost of the first M plans in the sorted sequence is smaller than i, then these plans can be executed in the same order. However, if the sum cost is larger than i, meaning that the percentile objective cannot be satisfied at the current probability level, the above process with the model corresponding to the next probability level can be repeated.

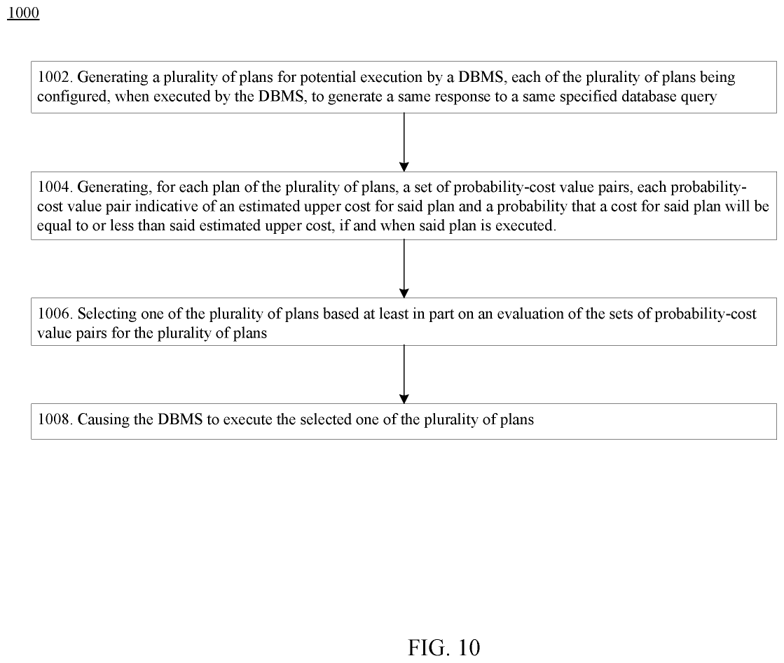

FIG. 10 illustrates a method for executing a single query, according to an embodiment of the present disclosure. In an embodiment the method 1000 can be performed by a computer such as or similar to the electronic device 1200. Additionally or alternatively, the method (and other methods as described herein) can be performed by a DBMS, which may include a computer or a plurality of networked computers. At 1002, the method may comprise generating a plurality of plans (e.g., plans 402 and 706) for potential execution by a DBMS, each of the plurality of plans being configured, when executed by the DBMS, to generate a same response to a same specified database query (e.g., query 1 of the queries 420, or query 702). It is noted that the computer or DBMS may receive the query and, in response to receiving the query, the computer or DBMS may generate the plurality of plans as described above and elsewhere herein.

At 1004, the method my further comprise generating, for each plan of the plurality of plans, a set of probability-cost value pairs (e.g., 406, 508 and 708), each probability-cost value pair indicative of an estimated upper cost for said plan and a probability (e.g., a) that a cost for said plan will be equal to or less than said estimated upper cost, if and when said plan is executed. At 1006, the method may further comprise selecting one of the plurality of plans based at least in part on an evaluation of the sets of probability-cost value pairs for the plurality of plans. The selection may be performed by a plan selector 414. At 1008, the method may further comprise causing the DBMS to execute the selected one of the plurality of plans. The DBMS may execute the selected plan and return a result to the query. The method may thus include providing this result to the query, for example to a computer or user. Similarly, an associated apparatus may be configured to provide the result to the query. Again, as mentioned above, in various embodiments the method may be performed by the DBMS. In this case, the DBMS may receive a query, generate plans as in 1002, generate probability-cost value pairs as in 1004, select one of the plans as in 1006, and cause itself to execute the selected plan as in 1008.

In some embodiments, the cost for said plan can be an amount of time that the DBMS takes to execute said plan. In some embodiments the estimated upper cost for said plan can be an estimated maximum amount of time that the DBMS will take to execute said plan.

In some embodiments, generating the set of probability-cost value pairs may comprise generating, for each said plan of the plurality of plans, a respective estimated cost (e.g., estimated costs 504, the costs 707) for said plan. In some embodiments, generating the set of probability-cost value pairs may further comprise, for each said plan of the plurality of plans, and for each probability value of a set of probability values, providing said probability value and said plan to an estimation module, which may be a portion of the uncertainty calibrator. In particular, the estimation module may be an apparatus which implements the conformal technique as described herein, either by performing operations according to the conformal technique itself, or invoking another device to perform the conformal technique upon its behalf.

In some embodiments, generating the set of probability-cost value pairs may further comprise, for each said plan of the plurality of plans, and for each probability value of a set of probability values, subsequently receiving, from the estimation module, a cost value such that, with probability equal to the probability value, an expected cost incurred by said plan is less than or equal to the cost value. For example, such information as received from the estimation module may be generated by the conformal technique as applied.

In some embodiments, generating the set of probability-cost value pairs may further comprise, for each said plan of the plurality of plans, and for each probability value of a set of probability values, setting one of the set of probability-cost value pairs to be equal to said probability value paired with said cost value. That is, output of the conformal technique is used to generate the probability-cost value pairs, for example as in cost distributions 406 and 508 of FIGS. 4 and 5A respectively, and table 708 of FIG. 7.

In some embodiments, the estimation module can operate based on a conformal technique (e.g., 506). In some embodiments, the conformal technique can be previously initialized based on a plurality of examples, each example indicative of a DBMS query plan, an estimated cost for said DBMS query plan, and an actual cost incurred by implementing the DBMS query plan.

In some embodiments, said selecting one of the plurality of plans can further be based on user-generated preferences (e.g., risk attitude 408). In some embodiments, said selecting one of the plurality of plans may comprise presenting output to a user and receiving input from the user in response to said output, the output indicative of the set of probability-cost value pairs each indexed to a corresponding one of the plurality of plans. For example, a user may be provided with cost distributions 406, 508, or 708, and the user indicates a preference (e.g., risk attitude 408) based on the cost distribution the user prefers. In some embodiments, said selecting one of the plurality of plans can be further based on a user-selected one of the plurality of plans and said selecting one of the plurality of plans may further comprise selecting the user-selected one of the plurality of plans.

In some embodiments, said selecting one of the plurality of plans may comprise selecting one of the plurality of plans which has a highest probability that the cost for said plan will be less than or equal to an indicated maximum acceptable single query cost. In some embodiments, the maximum acceptable single query cost is based on a user-generated preference (e.g., per-query threshold 606).

In some embodiments, the method may further comprise, based on an indication, operating in either a first mode or a second mode. In some embodiments, the first mode is characterized in that more certainty in cost is preferred rather than lower cost, and the second mode is characterized in that lower cost is preferred rather than more certainty in cost. For example, first mode may refer to the interaction mode and the second mode may refer to the execution mode of FIG. 6. In some embodiments, the indication is obtained from a user-generated preference. The user may indicate, via the interaction or execution mode 612, their preference for the plan selector 414 to select a plan.

In some embodiments, in the first mode (interaction mode), said selecting one of the plurality of plans may comprise selecting a probability level greater than 50% (e.g., α>50%). In some embodiments, in the first mode, said selecting one of the plurality of plans may further comprise comparing the plurality of plans based on their corresponding ones of the estimated upper costs which are paired with said selected probability level. For example, the plan selector 414 may select the plan with lowest upper cost of the all the plans with an a at some level more than 50%. In some embodiments, in the first mode, said selecting one of the plurality of plans may further comprise selecting one of the plurality of plans which has a lowest corresponding one of said estimated upper costs paired with said selected probability level.

In some embodiments, in the second mode, said selecting one of the plurality of plans may comprise selecting one of the plurality of plans which has a lowest estimated cost. In such cases, the estimated cost may take priority over the probability level a (e.g., when plan selector 414 operates in in the execution mode).

In some embodiments, said selecting one of the plurality of plans may comprise selecting a probability level greater than 50%. In some embodiments, said selecting one of the plurality of plans may further comprise comparing the plurality of plans based on their corresponding ones of the estimated upper costs which are paired with said selected probability level. For example, the plan selector 414 may select the plan with lowest upper cost of the all the plans with α>50%. In some embodiments, said selecting one of the plurality of plans may further comprise selecting one of the plurality of plans which has a lowest corresponding one of said estimated upper costs paired with said selected probability level. In some embodiments, the selected probability level is greater than one of: 60%, 70%, 80%, 90%, 95% and 99%. Thus, for each of the selected probably, the plan selector 414 may select, among the plans that satisfy the probability level a, the plan with the lowest estimated upper cost.

In some embodiments, the lowest estimated cost is generated by comparing respective costs for the plurality of plans, said respective costs generated independently of the set of probability-cost value pairs. For example, the plan selector may only consider the estimated costs (e.g., 504 or 707) in selecting the plan.

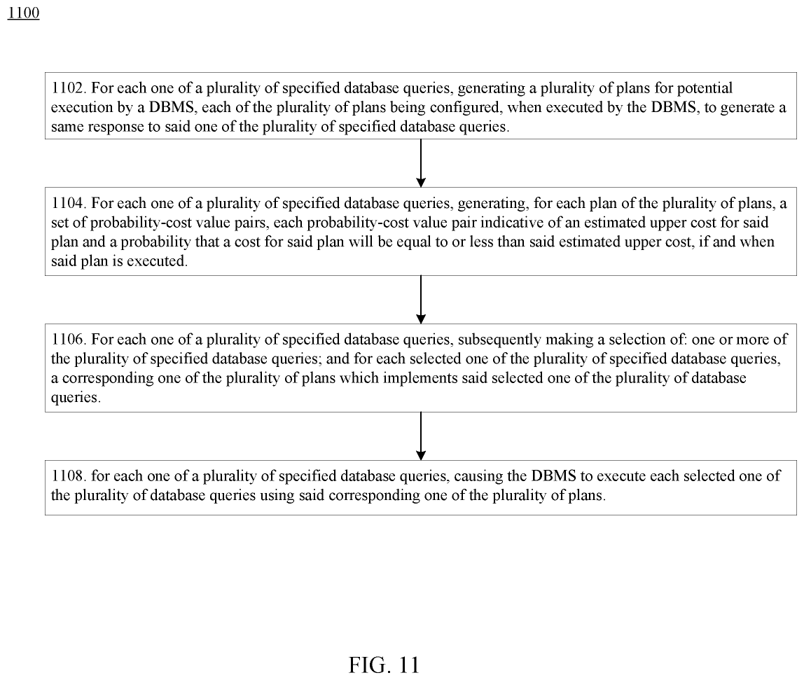

FIG. 11 illustrates another method for executing multiple queries, according to an embodiment of the present disclosure. In an embodiment, the method 1100 can be performed by a computer similar to the electronic device 1200. At 1102, the method may comprise, for each one of a plurality of specified database queries (e.g., 420), generating a plurality of plans (e.g., plans 402 and 706) for potential execution by a DBMS, each of the plurality of plans being configured, when executed by the DBMS, to generate a same response to said one of the plurality of specified database queries (e.g., query 1 of the queries 420, or query 702). In some embodiments, the method 1100 may comprise receiving, by the DBMS, the plurality of specified database queries. The method 1100 may further comprise, in response to said receiving, generating, by the DBMS, for each one of the received plurality of specified database queries, the plurality of plans for potential execution by the DBMS.

At 1104, the method may further comprise, for each one of a plurality of specified database queries, generating, for each plan of the plurality of plans, a set of probability-cost value pairs (e.g., 406, 508 and 708), each probability-cost value pair indicative of an estimated upper cost for said plan and a probability (e.g., a) that a cost for said plan will be equal to or less than said estimated upper cost, if and when said plan is executed.

At 1106, the method may further comprise (e.g., for each one of a plurality of specified database queries) subsequently making a selection of: one or more of the plurality of specified database queries, and for each selected one of the plurality of specified database queries, selecting a corresponding one of the plurality of plans which implements said selected one of the plurality of database queries. This may apply to, for example, cases where multiple queries (e.g., 420) are entered. In such cases, for each query (e.g., query 1, query 2, . . . ) of the queries 420, a plan is selected among multiple plans that each generate a same response to their respective query. In some embodiments, said selection can be based at least in part on an evaluation of the sets of probability-cost value pairs for the plurality of plans and for the plurality of specified database queries.

At 1108, the method may further comprise, for each one of a plurality of specified database queries, causing the DBMS to execute each selected one of the plurality of database queries using said corresponding one of the plurality of plans.

In some embodiments, said selection can further be based on an indication of an upper cost threshold and an indication that as many as possible of the plurality of specified database queries are to be completed while respecting the upper cost threshold. This may refer to, for example, making a plan selection based on the workload threshold 608. The plan selection may refer to the procedure of FIG. 8. Therefore, for example, the plan selection may be based on finishing as many queries as possible within a duration or amount of time τ.

In some embodiments, said making the selection may comprise selecting the one or more of the plurality of specified database queries. In some embodiments, said making the selection may further comprise, for each selected one of the plurality of specified database queries, selecting the corresponding one of the plurality of plans which implements said selected one of the plurality of database queries, such that the selection substantially maximizes a combination of: a number of the plurality of specified database queries which can be completed while respecting the upper cost threshold with a probability that meets or exceeds a specified probability level; and said specified probability level. For example, a batch of queries is presented, and a subset of the batch of queries is selected, and, for each query of the subset, a plan is selected, where the subset and the corresponding plans satisfy the objective.

In some embodiments, said selection can be further based on an indication of an upper cost threshold and an indication that at least a specified portion of the plurality of specified database queries is to be completed while respecting the upper cost threshold. This may refer to selecting plans based on the workload percentile criterion 610, as further described in the procedure 900 of FIG. 9. In some embodiments, said making the selection may comprise selecting the one or more of the plurality of specified database queries.

In some embodiments, said making selection may further comprise, for each selected one of the plurality of specified database queries, selecting the corresponding one of the plurality of plans which implements said selected one of the plurality of database queries, such that the selection substantially maximizes a probability that at least the specified portion of the plurality of specified database queries will be completed while respecting the upper cost threshold. Thus, for a given work workload of m queries, labeled Q₁, . . . , Qₘ, the objective may be that at least M (M∈[1, m]) queries are to be processed or finished, where M is the specified portion of the workload. The plan selector 414 may consider both the probability level and the estimated upper cost when making the plan selection to ensure, with adequate probability, that at least x % queries will be finished within a duration.

Embodiments described herein are not necessarily limited to DBMS applications, rather embodiments may be used in other tasks with cost-based candidate evaluation. For example, embodiments described herein may be applicable for selecting a path for data transmission in a network. In an embodiment, the path selection may be based on the transmission speed, for example, the fastest path for data transmission may be selected. In an embodiment, the transmission speed of each candidate path, between two points in a network, can be predicted, and the uncertainty of the prediction for each candidate path can be quantified based on embodiments described herein. In an embodiment, a user can be presented with related information (i.e., predicted transmission speed and corresponding uncertainty information), and the user can select a path according to the user's preference or customization (e.g., a risk-attitude based path selector, similar to the risk-attitude based plan selector of FIG. 6).

Accordingly, in an embodiment, a method may be provided that is based on a cost-based candidate evaluation task. The method may include calibrating the cost computation component using conformal technique to construct cost distributions. The method may further include specifying risk attitudes. Risk attitudes may be specified using for example options similar to the options indicated in embodiments of FIG. 6. The method may further include, selecting, from several candidate choices, the most desired one based on the specified risk attitude.

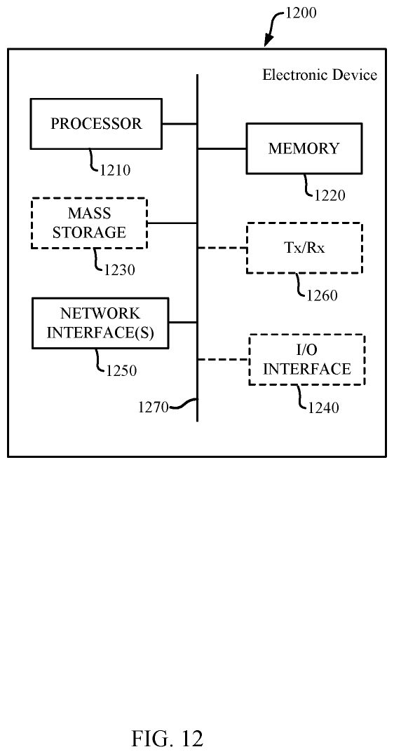

FIG. 12 is a schematic diagram of an electronic device 1200 that may perform any or all of operations of the above methods and features explicitly or implicitly described herein, according to different embodiments of the present invention. For example, a computer equipped with network function may be configured as electronic device 1200. The electronic device 1200 may be used to implement one or more embodiments described herein. For example, the electronic device 1200 may be configured to implement one or more components described herein including but not necessarily limited to: plan generator 704, cost estimator 404, uncertainty calibrator 412, plan selector 414, or a DMBS as the case may be. Multiple separate electronic devices may be provided, each configured to implement one or more of the components described herein, in a networked computing environment.

As shown, the electronic device 1200 may include a processor 1210, such as a Central Processing Unit (CPU) or specialized processors such as a Graphics Processing Unit (GPU) or other such processor unit, memory 1220, non-transitory mass storage 1230, input-output interface 1240, network interface 1250, and a transceiver 1260, all of which are communicatively coupled via bi-directional bus 1270. According to certain embodiments, any or all of the depicted elements may be utilized, or only a subset of the elements. Further, electronic device 1200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1220 may include any type of non-transitory memory such as static random access memory (SRAM), dynamic random access memory (DRAM), synchronous DRAM (SDRAM), read-only memory (ROM), any combination of such, or the like. The mass storage element 1230 may include any type of non-transitory storage device, such as a solid state drive, hard disk drive, a magnetic disk drive, an optical disk drive, USB drive, or any computer program product configured to store data and machine executable program code. According to certain embodiments, the memory 1220 or mass storage 1230 may have recorded thereon statements and instructions executable by the processor 1210 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a (e.g., non-transitory) computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, by a computer:
generating a plurality of plans for potential execution by a database management system (DBMS), each of the plurality of plans being configured, when executed by the DBMS, to generate a same response to a same specified database query;
generating, for each plan of the plurality of plans, a set of probability-cost value pairs, each probability-cost value pair indicative of an estimated upper cost for said plan and a probability that a cost for said plan will be equal to or less than said estimated upper cost, if and when said plan is executed;
selecting one of the plurality of plans based at least in part on an evaluation of the sets of probability-cost value pairs for the plurality of plans; and
causing the DBMS to execute the selected one of the plurality of plans.

2. The method of claim 1, wherein the cost for said plan is an amount of time that the DBMS takes to execute said plan and the estimated upper cost for said plan is an estimated maximum amount of time that the DBMS will take to execute said plan.

3. The method of claim 1, wherein generating the set of probability-cost value pairs comprises generating, for each said plan of the plurality of plans, a respective estimated cost for said plan.

4. The method of claim 1, wherein generating the set of probability-cost value pairs further comprises, for each said plan of the plurality of plans:
for each probability value of a set of probability values:
providing said probability value and said plan to an estimation module;
subsequently receiving, from the estimation module, a cost value such that, with probability equal to the probability value, an expected cost incurred by said plan is less than or equal to the cost value; and
setting one of the set of probability-cost value pairs to be equal to said probability value paired with said cost value.

5. The method of claim 4, wherein the estimation module operates based on a conformal technique.

6. The method of claim 5, wherein the conformal technique is previously initialized based on a plurality of examples, each example indicative of a DBMS query plan, an estimated cost for said DBMS query plan, and an actual cost incurred by implementing the DBMS query plan.

7. The method of claim 1, wherein said selecting one of the plurality of plans is further based on user-generated preferences.

8. The method of claim 1, wherein:
said selecting one of the plurality of plans comprises presenting output to a user and receiving input from the user in response to said output, the output indicative of the set of probability-cost value pairs each indexed to a corresponding one of the plurality of plans; and
said selecting one of the plurality of plans is further based on a user-selected one of the plurality of plans and said selecting one of the plurality of plans comprises selecting the user-selected one of the plurality of plans.

9. The method of claim 1, wherein said selecting one of the plurality of plans comprises selecting one of the plurality of plans which has a highest probability that the cost for said plan will be less than or equal to an indicated maximum acceptable single query cost.

10. The method of claim 9, wherein the maximum acceptable single query cost is based on a user-generated preference.

11. The method of claim 1, further comprising, based on an indication, operating in either a first mode or a second mode, wherein:
the first mode is characterized in that more certainty in cost is preferred rather than lower cost, and the second mode is characterized in that lower cost is preferred rather than more certainty in cost, and
wherein, in the first mode, said selecting one of the plurality of plans comprises:
selecting a probability level greater than 50%;
comparing the plurality of plans based on their corresponding ones of the estimated upper costs which are paired with said selected probability level; and
selecting one of the plurality of plans which has a lowest corresponding one of said estimated upper costs paired with said selected probability level; and
wherein, in the second mode, said selecting one of the plurality of plans comprises selecting one of the plurality of plans which has a lowest estimated cost.

12. The method of claim 11, wherein the indication is obtained from a user-generated preference.

13. The method of claim 1, wherein said selecting one of the plurality of plans comprises:
selecting a probability level greater than 50%;
comparing the plurality of plans based on their corresponding ones of the estimated upper costs which are paired with said selected probability level; and
selecting one of the plurality of plans which has a lowest corresponding one of said estimated upper costs paired with said selected probability level.

14. The method of claim 13, wherein the selected probability level is greater than one of: 60%, 70%, 80%, 90%, 95% and 99%.

15. The method of claim 11, wherein the lowest estimated cost is generated by comparing respective costs for the plurality of plans, said respective costs generated independently of the set of probability-cost value pairs.

16. A method comprising, by a computer:
for each one of a plurality of specified database queries:
generating a plurality of plans for potential execution by a database management system (DBMS), each of the plurality of plans being configured, when executed by the DBMS, to generate a same response to said one of the plurality of specified database queries; and
generating, for each plan of the plurality of plans, a set of probability-cost value pairs, each probability-cost value pair indicative of an estimated upper cost for said plan and a probability that a cost for said plan will be equal to or less than said estimated upper cost, if and when said plan is executed;
subsequently making a selection of: one or more of the plurality of specified database queries; and for each selected one of the plurality of specified database queries, a corresponding one of the plurality of plans which implements said selected one of the plurality of database queries;
wherein said selection is based at least in part on an evaluation of the sets of probability-cost value pairs for the plurality of plans and for the plurality of specified database queries; and
causing the DBMS to execute each selected one of the plurality of database queries using said corresponding one of the plurality of plans.

17. The method of claim 16, wherein said selection is further based on an indication of an upper cost threshold and an indication that as many as possible of the plurality of specified database queries are to be completed while respecting the upper cost threshold, and wherein said making the selection comprises selecting the one or more of the plurality of specified database queries; and for each selected one of the plurality of specified database queries, the corresponding one of the plurality of plans which implements said selected one of the plurality of database queries, such that the selection substantially maximizes a combination of: a number of the plurality of specified database queries which can be completed while respecting the upper cost threshold with a probability that meets or exceeds a specified probability level; and said specified probability level.

18. The method of claim 16, wherein said selection is further based on an indication of an upper cost threshold and an indication that at least a specified portion of the plurality of specified database queries is to be completed while respecting the upper cost threshold, and wherein said making the selection comprises selecting the one or more of the plurality of specified database queries; and for each selected one of the plurality of specified database queries, the corresponding one of the plurality of plans which implements said selected one of the plurality of database queries, such that the selection substantially maximizes a probability that at least the specified portion of the plurality of specified database queries will be completed while respecting the upper cost threshold.

19. An apparatus comprising:
a processor; and
non-transitory computer readable memory having stored thereon machine readable instructions which when executed by the processor configure the apparatus for:
generating a plurality of plans for potential execution by a database management system (DBMS), each of the plurality of plans being configured, when executed by the DBMS, to generate a same response to a same specified database query;
generating, for each plan of the plurality of plans, a set of probability-cost value pairs, each probability-cost value pair indicative of an estimated upper cost for said plan and a probability that a cost for said plan will be equal to or less than said estimated upper cost, if and when said plan is executed;
selecting one of the plurality of plans based at least in part on an evaluation of the sets of probability-cost value pairs for the plurality of plans; and
causing the DBMS to execute the selected one of the plurality of plans.

20. An apparatus comprising:
a processor; and
non-transitory computer readable memory having stored thereon machine readable instructions which when executed by the processor configure the apparatus for:
for each one of a plurality of specified database queries:
generating a plurality of plans for potential execution by a database management system (DBMS), each of the plurality of plans being configured, when executed by the DBMS, to generate a same response to said one of the plurality of specified database queries; and
generating, for each plan of the plurality of plans, a set of probability-cost value pairs, each probability-cost value pair indicative of an estimated upper cost for said plan and a probability that a cost for said plan will be equal to or less than said estimated upper cost, if and when said plan is executed;
subsequently making a selection of: one or more of the plurality of specified database queries; and for each selected one of the plurality of specified database queries, a corresponding one of the plurality of plans which implements said selected one of the plurality of database queries;
wherein said selection is based at least in part on an evaluation of the sets of probability-cost value pairs for the plurality of plans and for the plurality of specified database queries; and
causing the DBMS to execute each selected one of the plurality of database queries using said corresponding one of the plurality of plans.
